(19) United States
(12) Patent Application Publication
(10) Pub. No.: US 2024/0017701 A1
(43) Pub. Date: Jan. 18, 2024

(54) Method and Brake System for Emergency Stopping of a Commercial Vehicle

(71) Applicant: ZF CV Systems Global GmbH, Bern (CH)

(72) Inventor: Julian van Thiel, Grossburgwedel (DE)

(21) Appl. No.: 18/363,491

(22) Filed: Aug. 1, 2023

Related U.S. Application Data
(63) Continuation of application No. PCT/EP2022/052261, filed on Feb. 1, 2022.

(30) Foreign Application Priority Data
Feb. 15, 2021 (DE) 10 2021 103 478.7

(51) Int. Cl. B60T 7/12; B60T 8/32; B60T 8/94; B60T 8/1761; B60T 13/38; B60T 13/68; B60T 7/16

(52) U.S. Cl. CPC B60T 7/12; B60T 8/321; B60T 8/94; B60T 8/17616; B60T 13/385; B60T 13/683; B60T 7/16; B60T 2240/00; B60T 2250/04; B60T 2270/402; B60T 2270/403; B60T 2270/10; B60T 2250/02; B60T 2210/12

(57) ABSTRACT

A method is for the emergency stopping of a commercial vehicle. The vehicle has a pneumatic brake system with a primary service brake system and a parking brake system. The primary service brake system has a primary electronic service brake control unit for controlling the primary service brake system and service brake actuators. The parking brake system has an electronic parking brake control unit for controlling the parking brake system and parking brake actuators on at least one vehicle axle. The pneumatic brake system can receive an emergency stopping signal. The method includes: receiving the emergency stopping signal at the primary electronic service brake control unit; braking the commercial vehicle via the primary service brake system; ascertaining a commercial vehicle speed and, if this speed is below a predetermined speed threshold value and/or after a predetermined emergency stopping time: actuating the parking brake actuators via the parking brake system.

### CROSS-REFERENCE TO RELATED APPLICATIONS

This application is a continuation application of international patent application PCT/EP2022/052261, filed Feb. 1, 2022, designating the United States and claiming priority from German application 10 2021 103 478.7, filed Feb. 15, 2021, and the entire content of both applications is incorporated herein by reference.

### TECHNICAL FIELD

The disclosure relates to a method for the emergency stopping of a commercial vehicle, preferably an autonomous commercial vehicle, wherein the commercial vehicle has a pneumatic brake system with a primary service brake system and a parking brake system, which are supplied by at least one compressed air reservoir, wherein the primary service brake system has a primary electronic service brake control unit for controlling the primary service brake system and service brake actuators, wherein the parking brake system has an electronic parking brake control unit for controlling the parking brake system and parking brake actuators on at least one vehicle axle, and wherein the pneumatic brake system has wheel speed sensors, which provide wheel speed signals to the primary electronic service brake control unit and the electronic parking brake control unit. The disclosure also relates to a pneumatic brake system with an emergency stopping function for a commercial vehicle, preferably an autonomous commercial vehicle, including: a primary service brake system and a parking brake system, which are supplied by at least one compressed air reservoir, wherein the primary service brake system has a primary electronic service brake control unit for controlling the primary service brake system and service brake actuators, wherein the parking brake system has an electronic parking brake control unit for controlling the parking brake system and parking brake actuators on at least one vehicle axle; and wheel speed sensors, which provide wheel speed signals to the primary electronic service brake control unit and the electronic parking brake control unit.

### BACKGROUND

In modern electronically controllable pneumatic brake systems, which are used in particular in commercial vehicles which are intended for autonomous driving operation, it is important to provide measures which, in the event of a fault in the brake system, still permit reliable deceleration of the commercial vehicle. Here, there are approaches to use fully redundant brake systems, partially redundant brake systems, or only different levels in a brake system, so that, in the event of a fault in a first level of the brake system it is possible to continue to operate, at least to a limited extent, in a second level.

If, however, a double error occurs, for example, which affects both the primary brake system and the redundant brake system, there is a risk that the commercial vehicle can no longer be braked in a controlled manner. For such cases there is a need to provide a system that allows reliable deceleration of the vehicle.

A system which aims in particular to achieve a high remaining availability is known for example from US 2017/0267221. There, an electrical equipment of a vehicle including an at least partly electrical braking and steering device is disclosed, which includes: an electric or electromechanical steering device, which is connected to a steering transmission and includes an electronic steering controller as well as an electrical steering adjuster, and a service brake device. In US 2017/0267221, it is proposed that the service brake device is an electropneumatic service brake device which includes an electropneumatic service brake device, electronic brake control device, electropneumatic modulators, and pneumatic wheel brake actuators, wherein the electronic brake controller electrically controls the electropneumatic modulators in order to generate pneumatic brake pressures or brake control pressures for the pneumatic wheel brake actuators for individual wheels, for individual axles, or for individual sides. The electropneumatic service brake valve device has a service brake actuation member, and also within an electric service brake circuit an electrical channel with an electric brake value generator actuatable by the service brake actuation member. Furthermore, an electronic evaluation device receiving the actuation signals is provided, which inputs braking request signals into the electronic braking control device depending on the actuation signals, and also within at least one pneumatic service brake circuit includes at least one pneumatic channel, in which, by actuation of the service brake actuation member on account of a driver's braking request, at least one control piston of the service brake valve device is loaded by a first actuation force and the control piston, in response hereto, makes it possible to generate pneumatic brake pressures or brake control pressures for the pneumatic wheel brake actuators. The electronic evaluation device of the electropneumatic service brake valve device furthermore includes electronic control means for generating a second actuation force, independently of a driver's braking request, which, when a braking request independent of the driver's request is present, acts on the control piston in the same direction or in the opposite direction in relation to the first actuation force. The electropneumatic service brake device is supplied by an electrical energy source, which is independent of a second electrical energy source which supplies the electropneumatic service brake valve device with electrical energy. It is hereby ensured that at least one of the two systems, where possible, always functions. The electrical or electropneumatic steering device is supplied here with energy by the second electrical energy source. A high remaining availability is to be achieved hereby. However, the system is complex and therefore cannot be implemented readily in every commercial vehicle.

A system that provides an electronically pneumatically controlled redundancy is disclosed in US 2019/0152459. The system disclosed there uses a bypass valve in order to forward control pressures, depending on failure of a sub system, in order to thus supply the electrically failed circuit, at least pneumatically. The remaining availability is hereby also increased. Similar systems are disclosed in US 2019/0193705 and in US 2019/0248351.

Furthermore, US 2019/0248350 discloses a system and method in which pilot valves are electronically actuated via a redundancy signal if a failure or a defect in the electronic actuation of wheel brakes of the brake system is determined. The system attempts here to prevent the locking of wheels.

US 2020/0023820, US 2020/0023827, DUS 2020/0070795 and US 2020/0148180 disclose systems in each of which a redundancy is generated pneumatically. Here, different controlled brake pressures, for example front axle, rear axle or trailer brake pressures are used in order to provide these failed systems, for example the front axle brake circuit, rear axle brake circuit, parking brake circuit or trailer brake circuit, as redundancy pressure. In this way, a subordinate pneumatic redundancy level is generated, so that a high remaining availability is likewise achieved.

In addition, systems that incorporate the trailer also exist, as disclosed for example in US 2019/0248346.

DE 10 2017 001 409 A1 describes a method for controlling an autonomous vehicle including a vehicle control unit for controlling autonomous driving functions of the vehicle and including a brake control unit for controlling brake functions of a brake system, in particular a pneumatic brake system, of the vehicle with at least one braking device, in particular a parking brake. The braking device is activatable by the brake control unit and/or the vehicle control unit for braking and is deactivatable for driving by actuation of at least one switch element. The solution presented in DE 2017 001 409 A1 is distinguished in that the switch element, preferably a solenoid valve, has two electrical conductors for actuation, wherein one of the two conductors is switched by the brake control unit and the other of the two conductors is switched by the vehicle control unit.

The electrical connection presented in DE 10 2017 001 409 A1 of the brake valve to both the brake control unit and the vehicle control unit allows a fail safe set up. Specifically, in the event of failure or malfunction of already one of the two control units, the brake device is activated via the brake valve, since the electromagnet is then switched off. Here, each of the control units switches only the two conductors of the supply line of the electromagnet.

### SUMMARY

The disclosure proceeds from systems of this kind and acknowledges that these function well in principle and are suitable for a multitude of applications. However, there are applications in which a commercial vehicle, in particular formed as an autonomous commercial vehicle, is to be decelerated and stopped in the event of an error, which may also be located outside the commercial vehicle. Here, the disclosure has identified a need and aims to describe a method and a pneumatic brake system via which a commercial vehicle, in particular an autonomous commercial vehicle, can be reliably stopped.

In a first aspect, the disclosure solves the aforementioned problem by a method for the emergency stopping of a commercial vehicle, preferably an autonomous commercial vehicle, of the kind described at the outset, wherein the pneumatic brake system is configured to receive an emergency stopping signal and the method has the steps of: receiving the emergency stopping signal at the primary electronic service brake control unit; braking the commercial vehicle via the primary service brake system; ascertaining a commercial vehicle speed and, if this speed is below a predetermined speed threshold value and/or after a predetermined emergency stopping time: actuating the parking brake actuators via the parking brake system.

The disclosure is based on the idea that, when the emergency stopping signal is received, the commercial vehicle is initially to be decelerated by the primary service brake system, preferably to a standstill, and, as soon as a standstill has been reached, the service brake system actuates the spring brake actuators in order to secure the stopped state of the commercial vehicle. In other words, when the emergency stopping signal is received, a so called stop in lane maneuver is preferably performed and the commercial vehicle is braked right away. Alternatively or additionally to the speed dropping below the predetermined speed threshold value, the parking brake actuators are preferably also actuated when a predetermined emergency stopping time has elapsed. The emergency stopping time is preferably measured starting from receipt of the emergency stopping signal. This is preferred in particular when either a speed of the commercial vehicle cannot be detected or cannot be detected correctly or the deceleration by the primary service brake system is not functioning or is not functioning correctly, so that the speed of the commercial vehicle does not drop sufficiently quickly below the predetermined speed threshold value. In this case, an additional brake force can then be generated by activation of the parking brake actuators in order to reliably brake and stop the commercial vehicle.

The predetermined speed threshold value may be a speed of 0 m/s, so that this does not necessarily have to be dropped below, but merely has to be reached. However, the threshold speed value is preferably slightly higher, in particular 2 m/s or less, 1 m/s or less, 0.5 m/s or less. Such a range can be considered to be a standstill of the commercial vehicle.

The speed of the commercial vehicle is preferably measured via the wheel speed sensors, which provide wheel speed signals to the primary electronic service brake control unit and the electronic parking brake control unit and/or by one or more further sensors, for example sensors on a transmission, crankshaft, acceleration sensors, gyroscopes, and/or by assistance of radio technology, such as GPS.

The emergency stopping signal can be provided for example via an external switch, which is mounted on an outer side of the commercial vehicle. This is preferred in particular when the commercial vehicle is an autonomous commercial vehicle, which for example is used autonomously at a depot of a company. Should an error then occur, or a hazard situation, a member of staff could manually actuate the emergency stop button in order to thus trigger the braking of the commercial vehicle. Such an emergency stop button is preferably connected to the primary electronic service brake control unit and/or the electronic parking brake control unit, in order to thus provide the emergency stopping signal thereto. However, it may also be connected for example to a vehicle BUS of the commercial vehicle, in order to provide the emergency stopping signal via this vehicle BUS to the electronic control units and/or further units or entities. The emergency stopping signal, however, may likewise be received wirelessly. For this purpose, the pneumatic brake system preferably has a corresponding receiver, or the commercial vehicle has a wireless receiver of this kind, which is then connected to the pneumatic brake system, again optionally and with use of a vehicle BUS system. In this way, the emergency stopping signal can be provided for example from a remote transmitter, such as a remote control unit of a member of staff of the company or also via radio masts, which may be located at a depot of a company but may also be conventional cell phone towers, if the commercial vehicle is an autonomous commercial vehicle travelling in regular road traffic. The receiver of the commercial vehicle may preferably be a mobile radio receiver. It could likewise be provided that the emergency stopping signal is provided by further commercial vehicles which are located in the vicinity of the commercial vehicle. If, for example, a further commercial vehicle determines an error, it can be provided that this commercial vehicle sends the emergency stopping signal to the further commercial vehicles located in the environment in order to prompt them to brake.

Furthermore, the emergency stopping signal may preferably be an internal signal, which for example is provided by a superordinate unit, such as in particular a unit for autonomous driving, a security gateway, or further modules. This may be preferred in particular when the units for autonomous driving or the further modules identify a hazard situation, for example with the aid of optical or radar sensors, in order to thus stop the commercial vehicle immediately.

In a preferred development of the method, the emergency stopping signal is received also at the electronic parking brake control unit and, in the event that braking of the commercial vehicle by the primary service brake system is not possible, the commercial vehicle is braked by the parking brake system. In accordance with the disclosure it is therefore firstly checked whether the primary service brake system can brake the commercial vehicle. If this is not the case, for example because the primary service brake system has failed on account of a pneumatic, mechanical or electrical fault, the parking brake system takes over the deceleration and the braking of the commercial vehicle and then secures the standstill. Such a query can be sent for example from the electronic parking brake control unit to the primary electronic service brake control unit and, if no response is received back, or a time out signal is received or ascertained, the electronic parking brake control unit takes over the braking and stopping of the commercial vehicle. It can also be provided that the primary electronic service brake control unit instructs the electronic parking brake control unit directly to carry out the braking of the commercial vehicle.

In a further preferred embodiment, the pneumatic brake system includes a secondary service brake system, which is supplied by the or a further compressed air reservoir, wherein the secondary service brake system has a secondary electronic service brake control unit for controlling the secondary service brake system. The emergency stopping signal is also received at the secondary electronic service brake control unit and, in the event that braking of the commercial vehicle by the primary service brake system is not possible, the commercial vehicle is braked by the secondary service brake system. The emergency stopping signal can be provided via a parallel line or a bus system both to the primary electronic service brake control unit and the secondary electronic service brake control unit, or the primary electronic service brake control unit and the secondary electronic service brake control unit are connected in series. The secondary service brake system thus sits functionally between the primary service brake system and the parking brake system. According to this embodiment, the braking is to be carried out initially by the primary service brake system in response to the receipt of the emergency stopping signal. If this is not possible or is not possible correctly, the braking is to be carried out by the secondary service brake system. If this is also not possible or is not possible correctly, the braking is to be performed by the parking brake system. The emergency stopping signal can be provided, in this case too, directly to the secondary electronic service brake control unit, or this receives the emergency stopping signal via the vehicle bus or from one of the further modules, such as in particular the primary electronic service brake control unit and/or the electronic parking brake control unit.

That which has been described above in respect of the relationship between the primary service brake system and the parking brake system also applies in respect of the secondary service brake system. The secondary service brake system can then take over if the primary service brake system is not functioning or is not functioning correctly. To this end, the secondary service brake system can preferably query the primary service brake system and/or receive therefrom a time out signal or ascertain a time out signal of this kind. The secondary service brake system can also be instructed directly by the primary service brake system, by way of a prompting signal, to carry out the braking.

In the event that the primary service brake system and also the optionally provided secondary service brake system are unable to brake the commercial vehicle in response to the emergency stopping signal and the parking brake system is used to brake the commercial vehicle, the braking can be performed on the one hand immediately, and on the other hand in steps. Immediate braking is understood to mean that the parking brake actuators of the parking brake system are actuated immediately and preferably with maximum force. In steps means that the parking brake actuators are not actuated directly, but optionally initially with lower force. A locking of the corresponding axle on which the parking brake actuators are provided can thus be prevented. The stepped actuation of the parking brake actuators can preferably be performed in a slip controlled, speed dependent and/or friction coefficient dependent manner. For example, an ABS functionality can be implemented via the parking brake actuators. This can be implemented on the one hand by the electronic parking brake control unit or by another control unit, such as a separately provided ABS control unit. The reliability can hereby be increased, and a safe stop in lane maneuver can be performed. In the extreme case, locking of one or more vehicle axles may lead to unstable braking and to swerving of the vehicle, which is preferably prevented.

It is furthermore preferred that the method includes the step of: ascertaining the predetermined emergency stopping time. The predetermined emergency stopping time can be fixedly specified on the one hand and saved in an electronic module, but on the other hand it is preferably ascertained situation dependently, preferably by the brake system, preferably by the primary electronic control unit and/or the electronic parking brake control unit. It may also be defined by a superordinate unit, so that the ascertainment of the predetermined emergency stopping time may also be a retrieval of the value from a superordinate or other system.

The predetermined emergency stopping time may be defined on the basis of one or more parameters. Such parameters include the state variables of the primary or secondary service brake system, activity of an ABS function; wheel speed signals, speed of the commercial vehicle, preferably at the time of receipt of the emergency stopping signal, friction coefficient, expected friction coefficient and vehicle weight. Further parameters may likewise be used. The parameters can be combined and weighted differently. State variables of the primary or secondary service brake system are in particular fault states, remaining availabilities, pressures and compressed air reservoirs and the presence of additional driving stability functions, such as ABS, ASR, ESP and the like. Preferably, learned values or profiles of the brake system, preferably such as learned force transfer behavior of the service brake and/or parking brake actuators, learned slip values, learned friction values, learned values based on tires of the commercial vehicle are considered to be further parameters. In this way, the maximum brake force can be estimated under consideration of the friction value, preferably by an electronic control unit of the brake system.

The parking brake actuators preferably include one or more spring brake cylinders, which are opened when aerated and close when deaerated by a spring force. The step of braking the commercial vehicle by the parking brake system in this case preferably includes a venting of at least one of the spring brake cylinders. The advantage of spring brake cylinders of this kind lies in particular in the fact that they can close without pressure, whereas conventional service brake actuators are opened without pressure and close only when a pressure exceeding a limit value is applied. The spring brake cylinders can be provided on one or more vehicle axles. They are typically provided on the rear axle in the case of commercial vehicles. Spring brake cylinders can also be used as so called combi cylinders or tri stop cylinders together with service brake cylinders, so that hardly any additional installation space is required here.

The parking brake system preferably also has a parking brake valve unit, which is connected on the one hand to the or a further compressed air reservoir and on the other hand to the parking brake actuators, wherein the electronic parking brake control unit switches one or more valves of the parking brake valve unit in order to actuate the parking brake actuators by the parking brake system. Parking brake valve units of this kind are known in principle and can be used in different configurations. The electronic parking brake control unit can be integrated with the parking brake valve unit to form a module, wherein this is not mandatory. The electronic parking brake valve unit can also be integrated together with the primary electronic service brake control unit in a module or provided on a printed circuit board or can also form merely a software instance of the primary electronic service brake control unit. The parking brake valve unit can also be integrated with further valve units, such as in particular an axle modulator, front or rear axle modulator, trailer control valve, or the like. In particular, the integration of electronic parking brake control unit, parking brake valve unit and any trailer control unit provided to form a module is preferred and may be advantageous in respect of installation space.

In a variant, the parking brake valve unit is monostable and, by providing an electrical signal, preferably by the electronic parking brake control unit, is switched into a first switch position, in which the parking brake actuators are released. When the electrical signal ceases, the parking brake valve unit switches in a monostable manner into a second switch position, in which the parking brake actuators are closed. This can be implemented particularly easily if the parking brake actuators are spring brake cylinders of the above described kind. To release the parking brake actuators a compressed air is necessary in this case. The monostable parking brake valve unit can thus be configured such that it is normally closed and, when the signal is provided, is opened under application of current. To this end, a 3/2 way valve can be provided, for example, which, in a first stable, that is, de energized, switch position connects the spring brake cylinder to a ventilation means or to the environment and, in a second switch position, which the 3/2 way valve assumes when the signal is provided, connects the spring brake cylinder to the compressed air reservoir. Only when the signal is provided is the spring brake cylinder then connected to the compressed air supply and thus released. If the signal ceases, the 3/2 way valve is switched in a monostable manner into the first switch position, in which the spring brake cylinder is connected to the venting means, so that the spring brake cylinder in this case closes and brakes or stops the commercial vehicle.

Such a configuration of the parking brake valve unit is also referred to as a fail safe configuration. It is important here that the parking brake valve unit is tolerant in respect of single faults. This means that this configuration of the parking brake valve unit is preferred in particular when, besides the primary service brake system, the secondary service brake system is also provided, so that single errors in the primary service brake system can be compensated by the secondary service brake system. If the commercial vehicle is operated in a limited area, for example on company property only for internal purposes, such a monostable configuration of the parking brake valve unit can, however, be used also in non tolerant systems.

In a variant it is preferred that the parking brake valve unit is bistable and has a bistable valve and also a monostable holding valve, wherein the bistable valve has a stable release position and a stable closed position, wherein in the release position of the bistable valve the parking brake actuators can be released and in the closed position of the bistable valve the parking brake actuators can be closed. The holding valve then preferably confines a pressure controlled by the bistable valve in the release position. The method in this variant preferably further includes the steps of: switching the bistable valve into the release position to release the parking brake actuators; switching the holding valve into an activated switch position to confine the pressure controlled by the bistable valve; and switching the bistable valve into the closed position. Such a bistable valve can be electromagnetic by having two electromagnetic detent positions, or purely pneumatic via a self holding mechanism.

In a second aspect, the problem stated at the outset is solved by a pneumatic braking system with an emergency stopping function for a commercial vehicle, preferably an autonomous commercial vehicle, of the type described at the outset, wherein the primary electronic service brake control unit is configured to receive an emergency stopping signal, and, in response hereto, to brake the commercial vehicle by the primary service brake system, wherein the electronic parking brake control unit is configured to ascertain a commercial vehicle speed and, if this speed is below a predetermined speed threshold value and/or after a predetermined emergency stopping time, to actuate the parking brake actuators via the parking brake system.

It is to be understood that a method according to the first aspect of the disclosure and also the pneumatic brake system according to the second aspect of the disclosure have the same and similar sub aspects. In this regard, for embodiments of the pneumatic brake system according to the second aspect of the disclosure, reference is made fully to the above described embodiments of the method according to the first aspect of the disclosure.

In a third aspect, the problem stated at the outset is solved by a commercial vehicle, in particular an autonomous commercial vehicle, including a pneumatic brake system according to the second aspect of the disclosure, which is configured to carry out the method according to one of the above preferred embodiments of a method according to the first aspect of the disclosure. It can also be provided that the pneumatic brake system of the commercial vehicle according to the third aspect of the disclosure is configured differently from the pneumatic brake system according to the second aspect of the disclosure. The commercial vehicle according to the third aspect of the disclosure is preferably an autonomous commercial vehicle and, besides the pneumatic brake system, also has a drivetrain and also a unit for autonomous driving with corresponding peripheral devices.

### BRIEF DESCRIPTION OF DRAWINGS

The invention will now be described with reference to the drawings wherein:

FIG. 1 shows a schematic depiction of a commercial vehicle including pneumatic brake system;

FIG. 2 shows a detailed view of a parking brake valve unit; and,

FIG. 3 shows a schematic sequence of the method in the form of a block diagram.

### DETAILED DESCRIPTION

A commercial vehicle 1, which is preferably formed as an autonomous commercial vehicle 2, has a pneumatic brake system 4, which is electronically controllable. The pneumatic brake system 4 is used in the present case in the commercial vehicle 1, which is shown here heavily schematically and which is shown here with two front wheels 6a, 6b of a front axle VA and rear wheels 8a, 8b of a rear axle HA.

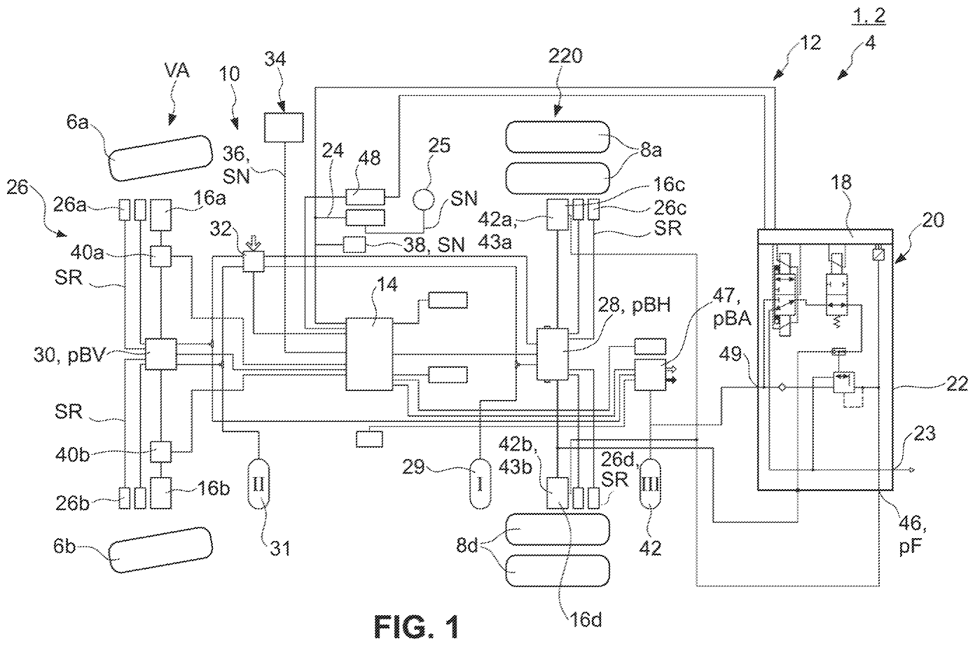

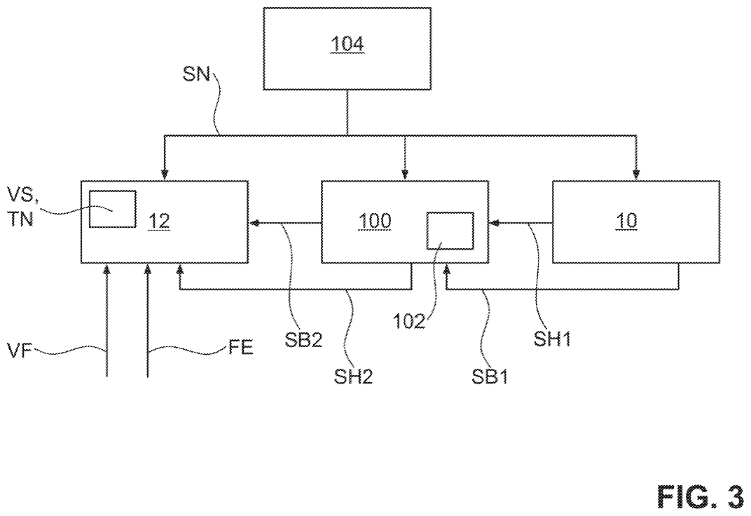

The pneumatic brake system 4, in the embodiment shown in FIG. 1, has a primary service brake system 10 and a parking brake system 12. In the embodiment shown here (FIG. 1) there is no secondary service brake system provided; in this regard see FIG. 3.

The primary service brake system 10 includes a primary electronic service brake control unit 14, which controls the primary service brake system and also the service brake actuators 16a, 16b, 16c, 16d associated therewith on the front axle VA and the rear axle HA. The parking brake system 12 has an electronic parking brake control unit 18, which is integrated here together with a parking brake valve unit 20, yet to be described hereinafter in greater detail, in a parking brake module 22. Both the primary electronic service brake control unit 14 and the parking brake control unit 18 are connected via a vehicle BUS 24 to a unit for autonomous driving 25. The unit for autonomous driving 25 provides in particular trajectory signals, which are then implemented by the primary electronic service brake control unit in order to brake the commercial vehicle 1.

Signals are also provided via the vehicle BUS 24 which originate from the pneumatic brake system 4, specifically in particular also signals from wheel speed sensors 26a, 26b, 26c, 26d. These can then be further processed by the primary electronic service brake control unit 14 or also the unit for autonomous driving 25. The primary electronic service brake control unit 14 controls a rear axle modulator 28 and a front axle modulator 30 in a manner known in principle. The rear axle modulator 28 is connected to a first compressed air reservoir 29 and is fed therefrom with a reservoir pressure, as is known in principle in the prior art. Depending on the brake signals provided at the primary electronic service brake control unit 14, the rear axle modulator 28 provides a rear axle brake pressure pBH at the rear axle service brake actuators 16c, 16d. The front axle modulator 30 is connected similarly to a second compressed air reservoir 31 and is fed therefrom. The front axle modulator 30 likewise receives brake signals from the primary electronic service brake control unit 14 and controls analogously a front axle brake pressure pBV at the service brake actuators 16a, 16b of the front axle VA. In this way, the commercial vehicle 1 can be electronically braked. In order to be able to brake the commercial vehicle 1 also manually, a brake value generator 32 is provided in the embodiment shown here (FIG. 1) and is connected pneumatically both to the first compressed air reservoir 29 and to the second compressed air reservoir 31 and can pneumatically trigger the control of the front axle brake pressure pBV and rear axle brake pressure pBH. This is also known in the prior art and will not be described in greater detail. The brake value generator 32 can also be omitted for autonomous commercial vehicles 2.

The brake system 4 is configured to receive an emergency stopping signal SN. In the embodiment shown in FIG. 1, three different ways of being able to receive the emergency stopping signal SN are shown by way of example. Firstly, an emergency stop switch 31 is shown schematically, which can be arranged for example on the outside of the commercial vehicle 1 so that it is easily accessible to staff located in the vicinity of the commercial vehicle 1. The emergency stop switch 34 is connected via an emergency stopping signal line 36 to the primary electronic service brake control unit 14 and provides the emergency stopping signal SN thereto. The emergency stop switch 34 may additionally (not shown here) also be connected to the electronic parking brake control unit 18 in order to be able to also provide the emergency stopping signal SN thereto directly. The emergency stop switch 34 could also be connected to the vehicle BUS 24. In the embodiment shown in FIG. 1, the emergency stopping signal SN is received by the primary electronic service brake control unit and is provided therefrom via the vehicle BUS 24 to other elements in the commercial vehicle 1.

As a second variant, it is shown in FIG. 1 that a wireless emergency stopping signal receiver 38 is provided in the commercial vehicle 1 and is coupled directly to the vehicle BUS 24. The wireless emergency stopping signal receiver 38 can be formed for example as a mobile radio receiver and can receive, via a remote transmitter, an emergency stopping signal SN, which it then provides via the vehicle BUS 24 to the corresponding units of the brake system 4.

As a further variant it is shown in FIG. 1 that the emergency stopping signal SN can also be a fully internal emergency stopping signal SN and in particular can be provided from the unit for autonomous driving 25. If this identifies that an emergency situation is present, in which an emergency stopping of the commercial vehicle 1 is necessary, it can output the emergency stopping signal SN, which is then received in the shown embodiment via the vehicle BUS 24 by the primary electronic service brake control unit 14 and the electronic parking brake control unit 18.

It can also be provided that two or all of these three variants are provided in a commercial vehicle 1. The disclosure is explicitly not limited to only one of these three variants or precisely one shown variant being implemented. Rather, it is decisive that the emergency stopping signal SN is received by the brake system 4.

As soon as the emergency stopping signal SN is received by the primary service brake system 10, specifically in particular by the primary electronic service brake control unit 14, the primary electronic service brake control unit 14 prompts the commercial vehicle 1 to be braked. To this end, it prompts the front axle modulator 30 to provide the front axle brake pressure pBV and the rear axle modulator 28 to provide the rear axle brake pressure pBH. These brake pressures pBV, pBH can be controlled, as is usual, in a slip controlled manner, also with use of ABS valves 40a, 40b, as are provided on the front axle VA. This braking is preferably performed with maximum deceleration, without the commercial vehicle 1 becoming unstable. A stop in lane maneuver is preferably performed in this way. Preferably, no further steering takes place here, in particular no evasive steering or the like. The commercial vehicle 1 is preferably stopped along the planned trajectory.

As soon as the speed of the commercial vehicle 1, which is ascertained either via the wheel speed sensors 26a d or via further units, such as the unit for autonomous driving 25, drops below a predetermined threshold value, it is assumed that the commercial vehicle 1 has reached a standstill, and the commercial vehicle 1 has been stopped as a result of the parking brake system 12 actuating parking brake actuators 42a, 42b of the parking brake system 12.

The parking brake system 12 is supplied with compressed air via a third compressed air reservoir 42. The electronic parking brake control unit 18 is connected via the vehicle BUS 24 to the unit for autonomous driving 25 and to the primary electronic service brake control unit 14. The electronic parking brake control unit 18 can additionally also be connected directly to the emergency stop switch 34, although this is not shown in FIG. 1. In order to actuate the parking brake actuators 42a, 42b, which are formed here as spring brake cylinders 43a, 43b, the parking brake module 21, prompted by the electronic parking brake control unit 18, deaerates the spring brake cylinders 43a, 43b, which then close. In driving operation, when the spring brake cylinders 43a, 43b are to be deaerated, the electronic parking brake control unit 18 prompts the control of a parking brake pressure pF at a spring brake connection 46 of the spring brake module 22 provided for this purpose. In the event that the speed of the commercial vehicle 1 does not drop below the predetermined threshold value, it is preferably provided that the parking brake system 12 actuates the parking brake actuators 42a, 42b once a predetermined emergency stop time has elapsed, in order to thus achieve braking of the commercial vehicle 1. The electronic parking brake control unit 18 can perform the deaeration of the spring brake cylinders 43a, 43b, which is required in this case, in a stepped manner so that locking of the rear axle HA can be avoided. To this end, the electronic parking brake control unit 18 can use wheel speed signals SR from the wheel speed sensors 26a 26d.

Also for the case that the primary electronic service brake control unit 14 cannot perform the braking in response to the emergency stopping signal SN or cannot perform such braking correctly, this is taken over by the electronic parking brake control unit 18. For this purpose, it can again be provided that the primary electronic service brake control unit 14 sends a corresponding request signal to the electronic parking brake control unit 18, or the parking brake control unit 18 determines that the primary electronic service brake control unit 14 is not functioning or is not functioning correctly, because the electronic parking brake control unit 18 receives a time out signal or the like. For this case, the electronic parking brake control unit 18 can carry out the braking of the commercial vehicle 1 in response to the receipt of the emergency stopping signal SN. For this purpose too, the electronic parking brake control unit 18 receives the emergency stopping signal SN.

The predetermined emergency stopping time can be ascertained on the one hand by the electronic parking brake control unit 18, the primary electronic service brake control unit 14, the unit for autonomous driving 25, or another superordinate or subordinate unit. In particular, the emergency stopping time can be determined on the basis of the speed VF of the commercial vehicle 1 received at the time of the emergency stopping signal SN, wheel speed signals SR from the wheel speed sensors 26a 26d, friction values FE, or other parameters (cf. also FIG. 3).

In the embodiment of the brake system 4 shown in FIG. 1, a trailer control valve 47 is also provided in addition and is likewise supplied with reservoir pressure from the third compressed air reservoir 42 and, at a trailer coupling head, controls a trailer brake pressure pBA for a potential connected trailer. The trailer control valve 47 may also be formed as a module and may have its own electronic control unit.

It is also conceivable and preferred that the primary electronic service brake control unit 14 is integrated with the rear axle modulator 28 and/or the front axle modulator 30 and module. It is also conceivable that the primary electronic service brake control unit 14 is integrated with the electronic parking brake control unit 18 in a structural unit, a printed circuit board, or the like. The two electronic control units 14, 18, however, are preferably separate. In the embodiment shown in FIG. 1, the primary electronic service brake control unit 14 and the electronic parking brake control unit 18 are supplied with electrical energy from a common voltage source 48. Here, however, it is conceivable and preferred that two separate voltage sources are provided for the primary electronic service brake control unit 14 and the electronic parking brake control unit 18, so that these can be supplied independently of one another with electrical energy. This is advantageous if one of the two voltage sources should fail, so that in each case the other of the electronic control units 14, 18 can continue to be operated. The parking brake valve unit 20 of the parking brake system 12 can be monostable or bistable.

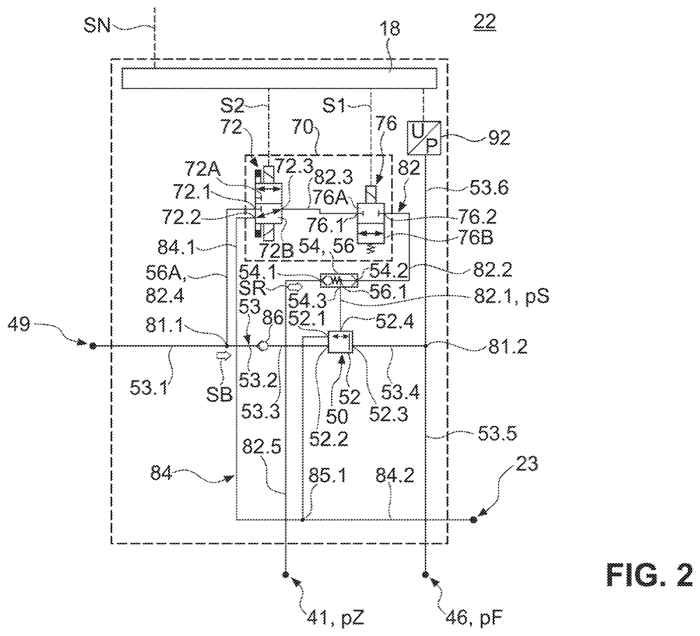

FIG. 2 illustrates an example of the parking brake valve unit 20 which is bistable.

A reservoir connection 49, to which a first main line portion 53.1 of a main line 53 connects, is configured to receive compressed air for the parking brake module 22 and in particular the parking brake valve unit 20. Further along the main line 53, between a second main line portion 53.2 and a third main line portion 53.3, there is arranged a main line check valve 86, which is configured to open in the filling direction, that is, in the direction a filling flow SP flowing from the reservoir connection 49 into the main line 53, and to block in the counter direction.

The third main line portion 53.3 is adjoined by a relay valve 52 of a main valve unit 50, wherein the relay valve 52 is connected via a second main valve connection 52.2 to the third main line portion 53.3. The relay valve 52 is configured to pneumatically connect the second main valve connection 52.2 and a third main valve connection 52.3 via corresponding application of pressure to a control connection 52.4, in order to provide the parking brake pressure pF at the third main valve connection 52.3. The third main valve connection 52.3 is in turn connected to a fourth main line portion 53.4. Via a second main line branch 81.2, the fourth main line portion 53.4 is connected on the one hand via a sixth main line portion 53.6 to a pressure sensor 92 and on the other hand 11 to provide the parking brake pressure pF 11 via a fifth main line portion 53.5 to a spring brake connection 46.

The main line 53 has, between its first main line portion 53.1 and the second main line portion 53.2, a first main line branch 81.1, from which a fourth control line portion 82.4 of a control line 82 leads to a first bistable valve connection 72.1 of a bistable valve 72 of a pilot valve assembly 70.

The bistable valve 72 of the pilot valve assembly 70 is formed as a bistable 3/2 way solenoid valve, which is shown in the present case in a deaeration position 72B. The bistable valve 72 is configured to produce, in an aeration position 72A CI not shown here 11 a pneumatic connection between the first bistable valve connection 72.1 and a third bistable valve connection 72.3.

The pilot valve assembly 70 has a holding valve 76. The third bistable valve connection 72.3 is connected via a third control line portion 82.3 of the control line 82 to a first holding valve connection 76.1 of the holding valve 76. The pilot valve assembly can also be formed as a structural unit, however, it is also equally possible that the bistable valve 72 and the holding valve 76 are formed as independent components.

The holding valve 76 in the present case is monostable and is preferably formed as a normally open 2/2 way solenoid valve and is shown in the present case in its holding position 76A. In the holding position 76A, which is present in particular when the holding valve 76 is energized, the pneumatic connection between the first holding valve connection 76.1 and a second holding valve connection 76.2 is separated.

A second control line portion 82.2 is connected to the second holding valve connection 76.2. The second control line portion 82.2 is then pneumatically connected to a second selection valve connection 54.2 of a selection valve 54 formed in the present case as a shuttle valve 56. The shuttle valve 56 has a bias spring 56.1, which presses a valve body with a spring force against a first selection valve connection 54.1 and thus holds the shuttle valve 54 in a first valve position under a spring bias. In this valve position, the second selection valve connection 54.2 is pneumatically connected to the third selection valve connection 54.3.

A first control line portion 82.1 is connected to the third selection valve connection 54.3 and is in turn pneumatically connected to the control connection 52.4 of the relay valve 52. By way of the application of the control connection 52.4, the relay valve 52 can be actuated to control the parking brake pressure pF at the third main valve connection 52.3.

By way of the selection valve unit 54, a further, alternative compressed air source can be connected to the control connection 52.4 for the purpose of actuating the relay valve 52. For this purpose, an auxiliary brake pressure connection 41 is pneumatically connected in the present case via a fifth control line portion 82.5 to the first selection valve connection 54.1. The auxiliary brake pressure can be, in particular, a manually controlled pressure, which serves to manually release the spring brake cylinders once the commercial vehicle 1 has stopped, for example once the emergency stopping signal SN has been received.

In the embodiment shown here, whichever of the first and second selection valve connections 54.1, 54.2 is at the higher pressure is always pneumatically connected via the shuttle valve 54 to the third selection valve connection 54.3. Here, according to the operating principle of a shuttle valve, the other selection valve connection 54.1, 54.2 is always blocked by the valve body 54.5, so that the pressures applied at both selection valve connections 54.1, 54.2 are not added together, thus avoiding a potentially damaging pressure overload at the control connection 52.4.

A second bistable valve connection 72.2 of the bistable valve 72 is connected by a first deaeration line portion 84.1 of a deaeration line 84. In a deaeration position 72B of the bistable valve, the third bistable valve connection 72.3 is pneumatically connected to the second bistable valve connection 72.2. In this deaeration position 72B, the third control line portion 82.3 of the control line 82 is thus pneumatically connected to the first deaeration line portion 84.1.

The first deaeration line portion 84.1 is connected to by a second deaeration line portion 84.2, which is in turn connected to a deaeration connection 23 of the parking brake module 22. A third deaeration line portion 84.3 extends from a first main valve connection 52.1 of the relay valve 52 to a deaeration line junction point wherein the deaeration line junction point 85.1 is arranged in the deaeration line 84 between the first deaeration line portion 84.1 and the second deaeration line portion 84.2.

An aeration and thus release of the spring brake cylinders 43a, 43b is thus implemented by way of a control of a control pressure pS at the control connection 52.4 of the relay valve, via which at least one spring brake cylinder 43a, 43b is aerated in order to release the parking brake.

In order to aerate the spring brake cylinders 43a, 43b in normal driving operation and thus release them, the holding valve 76 is initially switched to the release position 76b by providing a signal S1 from the electronic parking brake unit 18. The bistable valve 72 is then switched into the aeration position 72a, not shown in FIG. 2, so that the parking brake pressure pF is controlled at the spring brake connection 46. This is achieved by providing pressure from the reservoir connection 49 via the fourth control line portion 82.4, the bistable valve 72, the third control line portion 82.3, the opened holding valve 76, the second control line portion 82.2 and the first control line portion 82.1 as control pressure pS at the control connection 52.4 of the relay valve 52. This increases the volume of the control pressure pS and provides the volume increased pressure as parking brake pressure pF at the spring brake connection 46. The holding valve 76 can now initially be de energized again in order to thus confine the controlled control pressure pS and allow the parking brake pressure pF to be controlled independently of the switch position of the bistable valve 72. If the bistable valve 72 is now switched again to the deaeration position 72b, in which the second bistable valve connection 72.2 is connected to the deaeration connection 23, the control pressure pS can be removed by de energizing the holding valve 76, and consequently the spring brake connection 46 can likewise be deaerated. In this way, a fail safe configuration can be provided. This arrangement of the pilot unit 70 is understood to be a monostable conversion of the bistable pilot unit 70.

In the event that the parking brake valve unit 20 is to be fully bistable, the holding valve 76 can simply be omitted. In the event that the parking brake valve unit 20 is to be fully monostable, the holding valve 76 can likewise be omitted and the bistable valve 75 is to be replaced by a conventional 3/2 way valve, which is biased in the deaeration position 72b. The auxiliary brake pressure connection 41 can likewise be omitted, as can also the shuttle valve 54.

The parking brake valve unit 20 can also be formed without a relay valve 52. In this case, the bistable valve 72 or a corresponding monostable 3/2 way valve would be connected directly to the reservoir connection 49, the deaeration connection 23 and the spring brake connection 46, in order to connect it selectively to the reservoir connection 49 or the deaeration connection 23.

FIG. 3 now illustrates an overview. The individual elements are shown merely as blocks. Besides the primary service brake system 10, in the embodiment shown here (FIG. 3), a secondary service brake system 100 is also provided. This includes a secondary electronic service brake control unit 102, which for example can be housed in its own electronic control unit, for example the rear axle modulator 28 or the trailer control valve 47, or can be formed as an instance of the primary electronic service brake control unit 14. The secondary service brake system 100 relies on the same compressed air reservoir 29, 31, 42 as the primary service brake system 10 and also actuates the same service brake actuators 16a 16d. The secondary service brake system, however, can also be supplied by a further voltage source independent of the voltage source 48. It can also be provided that the secondary service brake system 100 relies on other additional compressed air reservoirs, not shown here in FIG. 1, or is fed exclusively from the third compressed air reservoir 42.

In terms of function, the secondary service brake system 102 is connected between the primary service brake system 10 and the parking brake system 12. When, from an emergency stop unit 104, which by way of example represents the emergency stop switch 34, the wireless emergency stop signal receiver 38 or another unit that can provide the emergency stopping signal SN provides the emergency stopping signal SN to all three systems, that is, the primary service brake system 10, the secondary service brake system 100 and the parking brake system 12. It can also be provided that the emergency stop unit 104 provides the emergency stopping signal SN only to one of these systems, and the systems 10, 12, 100 communicate with one another in order to provide the emergency stopping signal SN to all three systems.

In the embodiment shown here (FIG. 3), the primary service brake system 10 is additionally connected to the secondary service brake system 100 and provides thereto a primary health status SH1 and a primary stability status SB. The secondary service brake system 100 can ascertain on this basis whether the primary service brake system 10 is able to implement the emergency stopping signal SN and brake the commercial vehicle 1. If this is the case, the secondary service brake system 100 is not engaged. If the secondary service brake system 100 ascertains that the primary service brake system 10 is unable to implement the emergency stopping signal, the secondary service brake system 100 implements the emergency stopping signal and brakes the commercial vehicle 1 accordingly. Here too, it is again true that as soon as the speed drops below the speed threshold value VS (cf. FIG. 3), the parking brake system 12 is engaged and actuates the parking brake actuators 42a, 42b. Also if an emergency stopping time TS (cf. FIG. 3) is exceeded, the parking brake system 12 actuates the parking brake actuators 42a, 42b.

The parking brake system 12 in turn receives a secondary stability status SB2 and a secondary health status SH2 from the secondary service brake system 100 and ascertains, on that basis, whether the secondary service brake system is able to implement the emergency stopping signal SN. If this is not the case, the parking brake system 12 can also implement the braking of the commercial vehicle 1 in response to the receipt of the emergency stopping signal SN, preferably can brake the vehicle in steps, in order to thus perform a stop in lane maneuver. As soon as a standstill has been reached, the parking brake system 12 actuates the parking brake actuators 42a, 42b fully, in order to secure the commercial vehicle 1 in the stationary state. The parking brake system 12 additionally also receives a speed VF of the commercial vehicle 1 and a friction coefficient FE, which may correspond to an expected friction coefficient. The vehicle speed VF is preferably the vehicle speed that is present at the time of receipt of the emergency stopping signal SN. On this basis, the parking brake system 12 can ascertain whether the commercial vehicle 1 is at a standstill and/or whether its speed has dropped below the predetermined speed threshold value VS. The parking brake system 12 can also bring about a stepped braking of the commercial vehicle 1 on the basis of these parameters. The predetermined speed threshold value VS and the predetermined emergency stopping time TN are for this purpose saved in an internal memory of the parking brake system 12 or are ascertained therefrom.

It is understood that the foregoing description is that of the preferred embodiments of the invention and that various changes and modifications may be made thereto without departing from the spirit and scope of the invention as defined in the appended claims.

### List of Reference Sings (Part of the Description)

1 commercial vehicle
2 autonomous commercial vehicle
4 pneumatic brake system
6a, 6b front wheels
8a, 8b rear wheels
10 primary service brake system
12 parking brake system
14 primary electronic service brake control unit
16a, 16b, 16c, 16d service brake actuators
18 electronic parking brake control unit
20 parking brake valve unit
22 parking brake module
23 deaeration connection
24 vehicle BUS
25 unit for autonomous driving
26a, 26b, 26c, 26d wheel speed sensors
28 rear axle modulator
29 first compressed air reservoir
30 front axle modulator
31 second compressed air reservoir
32 brake value generator
34 emergency stop switch
36 emergency stopping signal line
38 wireless emergency stopping signal receiver
40b ABS valves
41 auxiliary brake pressure connection
42a, 42b parking brake actuators
43a, 43b spring brake cylinders
44 third compressed air reservoir
46 spring brake connection
47 trailer control valve
48 voltage source
49 reservoir connection
50 main valve unit
52 relay valve
52.1 first main valve connection
52.2 second main valve connection
52.3 third main valve connection
52.4 control connection
53 main line
53.1 first main line portion
53.2 second main line portion
53.3 third main line portion
53.4 fourth main line portion
53.5 fifth main line portion
53.6 sixth main line portion
54 selection valve
54.1 first selection valve connection
54.2 second selection valve connection
54.3 third selection valve connection
56 shuttle valve
56.1 bias spring
70 pilot valve assembly
72 bistable
72.1 first bistable valve connection
72.1 second bistable valve connection
72.3 third bistable valve connection
72A aeration position
72B deaeration position
76 holding valve
76.1 first holding valve connection
76.2 second holding valve connection
76A holding position
76B release position
81.1 first main line branch
81.2 second main line branch
82 control line
82.1 first control line portion
82.2 second control line portion
82.3 third control line portion
82.4 fourth control line portion
84 deaeration line
84.1 first deaeration line portion
84.2 second deaeration line portion
84.3 third deaeration line portion
85.1 deaeration line junction point
86 main line check valve
92 pressure sensor
100 secondary service brake system
102 secondary electronic service brake control unit
104 emergency stopping unit
FE friction coefficient
HA rear axle
pBA trailer brake pressure
pBH rear axle brake pressure
pBV front axle brake pressure
pF parking brake pressure
pS pressure controlled by the bistable valve
SB filling flow
SB1 primary stability status
SB2 secondary stability status
SH1 primary health status
SH2 secondary health status
SN emergency stopping signal
SR wheel speed signal
TN predetermined emergency stopping time
VA front axle
VF speed
VS predetermined speed threshold valve

1. A method for the emergency stopping of a commercial vehicle, the commercial vehicle having a pneumatic brake system with a primary service brake system and a parking brake system, which are supplied by at least one compressed air reservoir, the primary service brake system having a primary electronic service brake control unit for controlling the primary service brake system and a plurality of service brake actuators, the parking brake system having an electronic parking brake control unit for controlling the parking brake system and a plurality of parking brake actuators on at least one vehicle axle, the pneumatic brake system having a plurality of wheel speed sensors, which provide wheel speed signals to the primary electronic service brake control unit and the electronic parking brake control unit, and the pneumatic brake system being configured to receive an emergency stopping signal; the method comprising:
receiving the emergency stopping signal at the primary electronic service brake control unit;
braking the commercial vehicle via the primary service brake system; and,
ascertaining a commercial vehicle speed and, if at least one of the commercial vehicle speed is below a predetermined speed threshold value and a predetermined emergency stopping time has elapsed, actuating the parking brake actuators via the parking brake system.

2. The method of claim 1, wherein the emergency stopping signal is received also at the electronic parking brake control unit and, in an event that braking of the commercial vehicle by the primary service brake system is not possible, braking the commercial vehicle via the parking brake system.

3. The method of claim 1, wherein the pneumatic brake system has a secondary service brake system supplied by the compressed air reservoir or a further compressed air reservoir; the secondary service brake system has a secondary electronic service brake control unit for controlling the secondary service brake system; the emergency stopping signal is also received at the secondary electronic service brake control unit; and, in an event that braking of the commercial vehicle by the primary service brake system is not possible, braking the commercial vehicle by the secondary service brake system.

4. The method of claim 3, wherein, in the event that braking of the commercial vehicle by the secondary service brake system is not possible, braking the commercial vehicle by the parking brake system.

5. The method of claim 2, wherein the commercial vehicle is braked by the parking brake system directly or in steps.

6. The method of claim 2, wherein the commercial vehicle is braked by the parking brake system directly or in steps in a slip controlled, speed dependent or friction coefficient dependent manner.

7. The method of claim 1 further comprising ascertaining the predetermined emergency stopping time on a basis of at least one parameter including at least one of:
state variables of the primary service brake system or a secondary service brake system;
activity of an ABS function; wheel speed signals; speed of the commercial vehicle; friction coefficient; expected friction coefficient; vehicle weight; learned values or profiles of the brake system.

8. The method of claim 1, wherein the emergency stopping signal is provided from a permanently wired emergency stop switch of the commercial vehicle, wirelessly from a remote transmitter, and/or from a transmitter inside the commercial vehicle.

9. The method of claim 1, wherein the parking brake actuators include at least one spring brake cylinder, which is configured to be opened when aerated and closed when deaerated by a spring force; and, said braking the commercial vehicle by the parking brake system includes a venting of at least one of said at least one spring brake cylinder.

10. The method of claim 1, wherein the parking brake system has a parking brake valve unit; the parking brake valve unit is connected to the compressed air reservoir or a further compressed air reservoir and to the parking brake actuators; and, the electronic parking brake control unit switches one or more valves of the parking brake valve unit in order to actuate the parking brake actuators via the parking brake system.

11. The method of claim 10, wherein the parking brake valve unit is monostable; the parking brake valve unit is configured to be switched into a first switch position in which the parking brake actuators are released via provision of an electrical signal; and, the parking brake valve unit is further configured to be switched in a monostable manner into a second switch position in which the parking brake actuators are closed when the electrical signal ceases.

12. The method of claim 10, wherein the parking brake valve unit is bistable and has a bistable valve and also a monostable holding valve; the bistable valve has a stable release position and a stable closed position; in the release position of the bistable valve, the parking brake actuators are releasable and, in the closed position of the bistable valve, the parking brake actuators are closeable; and, the monostable holding valve is configured to confine a pressure controlled by the bistable valve in the release position; the method further comprising:
switching the bistable valve into the release position to release the parking brake actuators;
switching the holding valve into an activated switch position to confine the pressure controlled by the bistable valve; and,
switching the bistable valve into the closed position.

13. A pneumatic brake system with an emergency stopping function for a commercial vehicle, the pneumatic brake system comprising:
a primary service brake system and a parking brake system, which are supplied by at least one compressed air reservoir;
said primary service brake system having a primary electronic service brake control unit for controlling the primary service brake system and service brake actuators;
said parking brake system having an electronic parking brake control unit for controlling the parking brake system and parking brake actuators on at least one vehicle axle;
a plurality of wheel speed sensors configured to provide wheel speed signals to the primary electronic service brake control unit and the electronic parking brake control unit;
said primary electronic service brake control unit being configured to receive an emergency stopping signal and, in response to receiving said emergency stop signal, to brake the commercial vehicle via said primary service brake system; and,
said electronic parking brake control unit being configured to ascertain the commercial vehicle speed and to at least one of:
actuate said parking brake actuators via said parking brake system if the commercial vehicle speed is below a predetermined speed threshold value, and,
actuate said parking brake actuators via said parking brake system after a predetermined emergency stopping time.

14. The pneumatic brake system of claim 13, wherein said electronic parking brake control unit is configured to receive said emergency stopping signal and, in an event that braking of the commercial vehicle by said primary service brake system is not possible, to brake the commercial vehicle via the parking brake system.

15. The pneumatic brake system of claim 13 further comprising:
a secondary service brake system configured to be supplied by the at least one compressed air reservoir or a further compressed air reservoir;
said secondary service brake system having a secondary electronic service brake control unit for controlling said secondary service brake system; and,
said secondary electronic service brake control unit being configured to receive said emergency stopping signal and, in an event that braking of the commercial vehicle via said primary service brake system is not possible, braking the commercial vehicle via said secondary service brake system.

16. The pneumatic brake system of claim 15, wherein said electronic parking brake control unit is configured to brake the commercial vehicle in an event that braking of the commercial vehicle via said secondary service brake system is not possible.

17. The pneumatic brake system of claim 14, wherein said electronic parking brake control unit is configured to brake the commercial vehicle directly or in steps.

18. The pneumatic brake system of claim 14, wherein said electronic parking brake control unit is configured to brake the commercial vehicle directly or in steps in a slip controlled, speed dependent or friction coefficient dependent manner.

19. The pneumatic brake system of claim 13, wherein said electronic parking brake control unit is configured to ascertain the predetermined emergency stopping time on a basis of at least one of: state variables of said primary service brake system or of a secondary service brake system; activity of an ABS function; wheel speed signals; speed of the commercial vehicle; friction coefficient; expected friction coefficient; vehicle weight.

20. The pneumatic brake system of claim 13 further comprising a connection for a permanently wired emergency stop switch via which said emergency stopping signal is configured to be triggered.

21. The pneumatic brake system of claim 13 further comprising a wireless receiver for receiving said emergency stopping signal provided by a remote transmitter.

22. The pneumatic brake system of claim 13, wherein said primary electronic service brake control unit is configured to receive said emergency stopping signal from a transmitter inside the commercial vehicle.

23. The pneumatic brake system of claim 13, wherein said parking brake actuators include at least one spring brake cylinder configured to be open when aerated and to close by a spring force when deaerated.

24. The pneumatic brake system of claim 12, wherein said parking brake system has a parking brake valve unit connected to the at least one compressed air reservoir or a further compressed air reservoir and to said parking brake actuators; and, said electronic parking brake control unit is configured to switch one or more valves of said parking brake valve unit in order to actuate said parking brake actuators via said parking brake system.

25. The pneumatic brake system of claim 24, wherein said parking brake valve unit is monostable; said parking brake valve unit being configured to be switched into a first switch position in which said parking brake actuators are released via provision of an electrical signal; and, said parking brake valve unit being further configured to be switched in a monostable manner into a second switch position in which said parking brake actuators are closed when the electrical signal ceases.

26. The pneumatic brake system of claim 24, wherein said parking brake valve unit is bistable and has a bistable valve and also a monostable holding valve; said bistable valve has a stable release position and a stable closed position; in the release position of said bistable valve, said parking brake actuators are releasable and, in the closed position of said bistable valve said parking brake actuators are closeable; and, said holding valve is configured to confine a pressure controlled by the bistable valve in said release position.

27. A commercial vehicle comprising a pneumatic brake system of claim 13.

28. The commercial vehicle of claim 27, wherein the commercial vehicle is an autonomous commercial vehicle.
